(19) United States
(12) Patent Application Publication
(10) Pub. No.: US 2009/0125821 A1
(43) Pub. Date: May 14, 2009

(54) GRAPHICAL USER INTERFACE FEATURE FOR ENABLING FASTER DISCRETE NAVIGATION AMONG MONITORS IN A MULTIPLE MONITOR WORKSTATION

(76) Inventor: Carolynn Rae Johnson, Allison Park, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/937,138

(22) Filed: Nov. 8, 2007

(51) Int. Cl. G06F 3/00

(52) U.S. Cl. 715/761

(57) ABSTRACT

A method of navigating among a plurality of monitors of a multiple monitor workstation. The method includes steps of receiving a request to navigate among the monitors when a position indictor, such as a mouse pointer, is displayed on a first one of the monitors that is active, in response to the request, displaying a navigation interface mechanism on the first one of the monitors that includes a plurality of monitor representations, with each of the monitor representations corresponding to a respective one of the monitors, receiving a selection of one of the monitor representations that corresponds to a second one of the monitors, and making the second one of the monitors active and displaying the position indicator on the second one of the monitors.

### FIELD OF THE INVENTION

The present invention relates to multiple monitor workstations, and in particular to a graphical user interface feature for use in a workstation having multiple monitors which enables faster discrete navigation among the monitors of the workstation.

### BACKGROUND OF THE INVENTION

The most common current day approach to supporting the use of a graphical user interface (such as the windowing interface provided with Windows, MacOS, OS/2, etc.) on a workstation with multiple monitors entails stretching the virtual “desktop” or graphical background of the graphical user interface across the multiple monitors and permitting the user of such a workstation to move the pointer or similar position indicator among the multiple monitors by moving a pointing device, such as a mouse or trackball, in the very same manner in which the user would do so if the workstation had only one monitor. Unfortunately, as the quantity of monitors increases, the dimensions of that virtual desktop also increase such that the operation of such a pointing device to move the pointer from one extreme end of such a virtual desktop to another becomes cumbersome.

Where a mouse is used to move a pointer across multiple monitors, the mouse is typically operated with a succession of moves across a flat surface in the desired direction interspersed with a succession of instances of picking up the mouse to move it in the other direction and placing it down on the flat surface to make possible another move in the desired direction. Where a trackball is used, the user's hand must be put through a similar pattern of repeated successions of moving the trackball in the desired direction interspersed with instances of picking up the hand to move it in the opposite direction and placing the hand down on the trackball to make possible another move of the trackball in the desired direction.

Such operation of such pointing devices is inconvenient, and may result in the infliction of carpal tunnel syndrome or some other form of repetitive stress injury on the user. Furthermore, in the field of railway control systems where there are often workstations having multiple monitors to allow a single operator to watch over multiple sections of railway, there is a need for the operator to be able to quickly move the pointer to a monitor on which a section of track is displayed for which some action is required. The above-described repetitive movements to move the pointer may not allow the operator to move the pointer fast enough to efficiently perform those actions. There is also a significant problem in current systems with inadvertently clicking on displayed items while trying to traverse an area on one or more monitors in the manners just described. In most multiple monitor situations, this is merely inconvenient, but in railway control systems (e.g., dispatching systems), this could result in advertently changing a switch position or a signal state.

One known solution has been to “speed up” the movement of the pointer in the sense that every movement of a pointing device is responded to with the pointer being caused to travel a greater distance across the virtual desktop than might be used with a workstation having only a single monitor. Unfortunately, this approach has the draw-back of reducing the accuracy with which the pointer can be positioned at a desired location, such as over a cell or on-screen control, since even minute movements of a pointing device are responded to with rather exaggerated movements of the pointer. This speed-accuracy tradeoff is defined by an ergonomic principle called Fitts's Law. Thus, there is a need for an improved method of enabling navigation among monitors in a multiple monitor workstation.

### SUMMARY OF THE INVENTION

In one embodiment, the present invention provides a method of navigating among a plurality of monitors of a multiple monitor workstation. The method includes steps of receiving a request to navigate among the monitors when a position indictor, such as a mouse pointer, is displayed on a first one of the monitors that is active, in response to the request, displaying a navigation interface mechanism on the first one of the monitors that includes a plurality of monitor representations, with each of the monitor representations corresponding to a respective one of the monitors, receiving a selection of one of the monitor representations that corresponds to a second one of the monitors, and making the second one of the monitors active and displaying the position indicator on the second one of the monitors. The method may further include deactivating the first one of the monitors and no longer displaying the position indicator on the first one of the monitors after the step of receiving a selection of one of the monitors. Preferably, each of the monitor representations is a cell, such as a user selectable icon, displayed on the first one of the monitors that together form a grid. Also preferably, the monitors are arranged in a particular arrangement, and a position of each of the cells in the grid corresponds to a position of the monitor to which the cell corresponds in the arrangement. The method may further included distinguishing the monitor representation for the active monitor from the other monitor representations, such as by providing in a different color or shading or with a different border. The method may also further include determining a set of X,Y coordinates of the position indicator on the first one of the monitors, wherein the step of displaying the position indicator on the second one of the monitors comprises displaying the position indicator at a position on the second one of the monitors corresponding to the set of X,Y coordinates.

In another embodiment, the invention relates to a computer readable medium having computer executable instructions for performing one or more of the various embodiments of the method just described. In still another embodiment, the invention relates to a workstation that includes a plurality of monitors, a processing unit operatively coupled to each of the monitors, and a memory operatively coupled to the processing unit having one or more routines executable by the processing unit that are adapted to perform one or more of the various embodiments of the method just described.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic representation of a dispatcher's workstation according to one embodiment of the invention;

FIG. 2 shows one of the monitor of the workstation of FIG. 1 having a portion of the track line being monitored displayed thereon;

FIGS. 3 and 4 show the monitor of FIG. 1 with a discrete navigation interface mechanism according to an aspect of the invention displayed thereon;

FIG. 5 shows another one of the monitors of the workstation of FIG. 1 that is selected and made active using the navigation interface mechanism of the present invention; and

FIG. 6 is a flowchart which illustrates a method of facilitating navigation among multiple monitors in a multiple monitor workstation according to one embodiment of the invention.

### DESCRIPTION OF THE PREFERRED EMBODIMENTS

The present invention provides a mechanism by which a user of a multiple monitor workstation is able to immediately transfer the pointer or a similar position indicator, such as a cursor, from one monitor to another one of the monitors (preferably at the same X,Y coordinates), thus skipping all intervening spaces. As a result, the solution provided by the present invention is less time consuming, less error prone and will likely result in reduced wrist fatigue for the user. For illustrative purposes, the present invention will be described in connection with a dispatcher's workstation used for railway traffic control. It should be understood, however, that this is being done for illustrative purposes only and that the present invention may be employed in multiple monitor workstations used in a number of different applications regardless of the arrangement of the monitors or the content shown on the monitors.

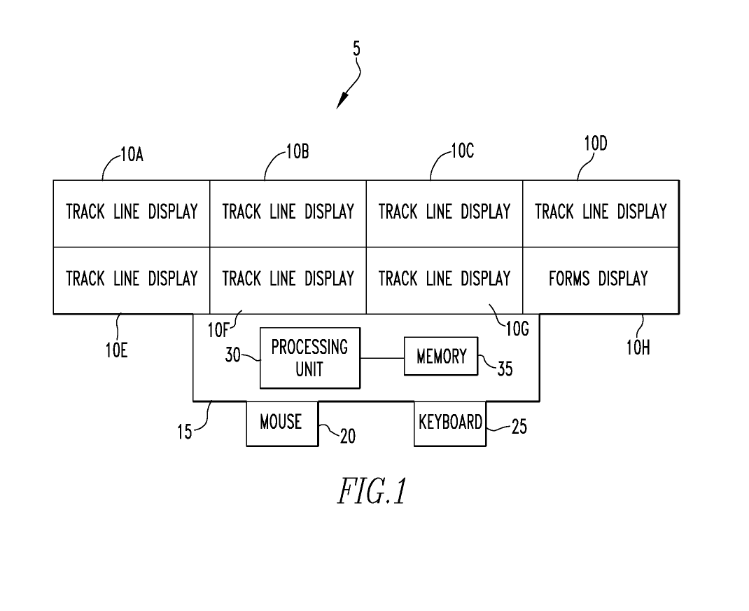

FIG. 1 is a schematic representation of a dispatcher's workstation 5 according to one embodiment of the invention. The dispatcher's workstation 5 includes a plurality of monitors 10A through 10H, which may be, for example, LCD and/or CRT monitors, and a computer base unit 15 operatively coupled to the monitors 10A through 10H. In addition, the dispatcher's workstation 5 includes a mouse 20 (or a similar input/navigation device such as a trackball) to enable the user to navigate on and between the various monitors 10A through 10H and to input commands into the computer base unit 15, and a keyboard 25 or a similar input device for enabling a user to enter information and commands into the computer base unit 15. The computer base unit 15 includes a processing unit 30, such as a microprocessor, a microcontroller or any other suitable processor, and a memory 35 operatively coupled thereto. The memory 35 may be any of a variety of types of internal and/or external storage media such as, without limitation, RAM, ROM, EPROM(s), EEPROM(s), and the like, alone or in combination, that provide a storage register for data storage. The memory 35 further includes a number of applications executable by the processing unit 30 for the processing of data. The applications can be in any of a variety of forms such as, without limitation, software, firmware, and the like, and the term “application” herein shall include one or more routines, sub-routines, function calls or the like, alone or in combination. As seen in FIG. 1, the dispatcher's workstation 5 includes multiple monitors 10A through 10H, with the monitors 10A through 10G each being dedicated to displaying a particular portion of track line being monitored by the dispatcher, and with the monitor 10H being dedicated to displaying necessary and required forms for use by the dispatcher.

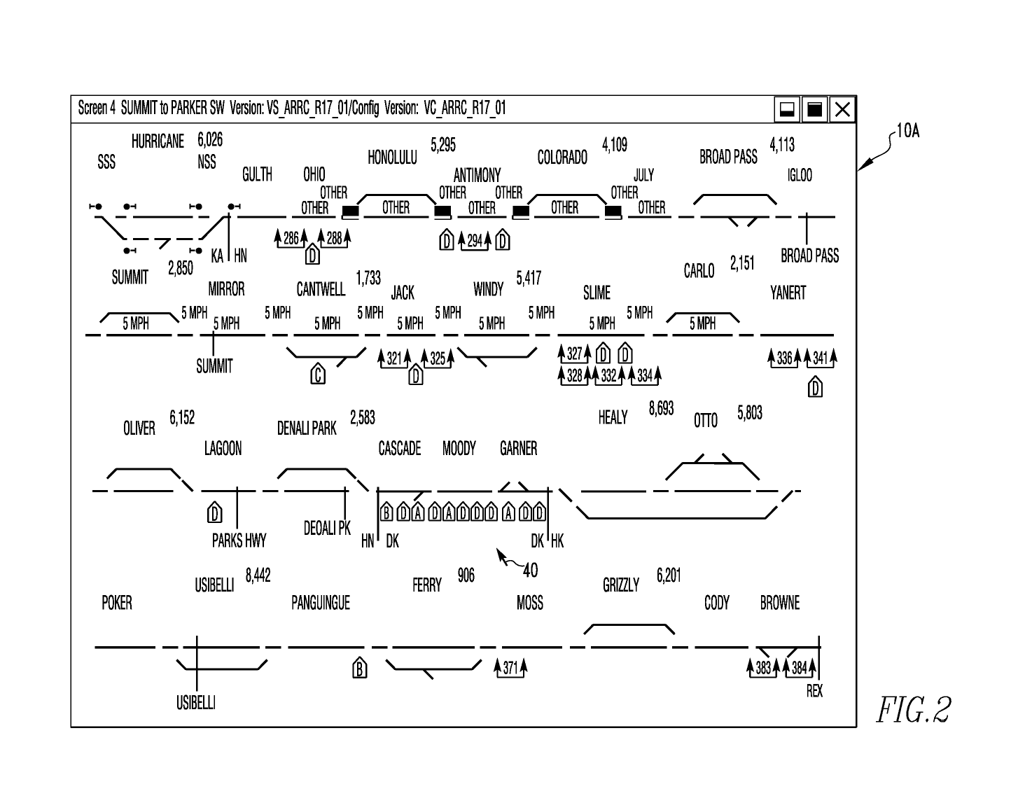

FIG. 2 shows monitor 10A having a portion of the track line being monitored by the dispatcher displayed thereon. As seen in FIG. 2, the monitor 10A has a position indicator in the form of a pointer 40 displayed thereon that may be selectively moved by the dispatcher using the mouse 20. If the dispatcher wishes to move the pointer 40 from the monitor 10A to the monitor 10H, which is the dedicated forms display monitor, the dispatcher, in prior art systems, would normally be required to traverse several intervening monitors with the pointer 10 (i.e., several of the monitors 10B through 10G). However, according to an aspect of the present invention, the dispatcher is able to move the pointer 40 among the various monitors 10A through 10H while skipping intervening monitors. In particular, when the dispatcher wishes to move the pointer 40 from the monitor 10A to a different monitor, i.e., one of monitors 10B through 10H, the dispatcher would, according to an aspect of the present invention, activate a discrete navigation interface function that is implemented by the dispatcher workstation 5. This may be done, for example, through a click of one of the buttons forming a part of the mouse 20, or by some other suitable method.

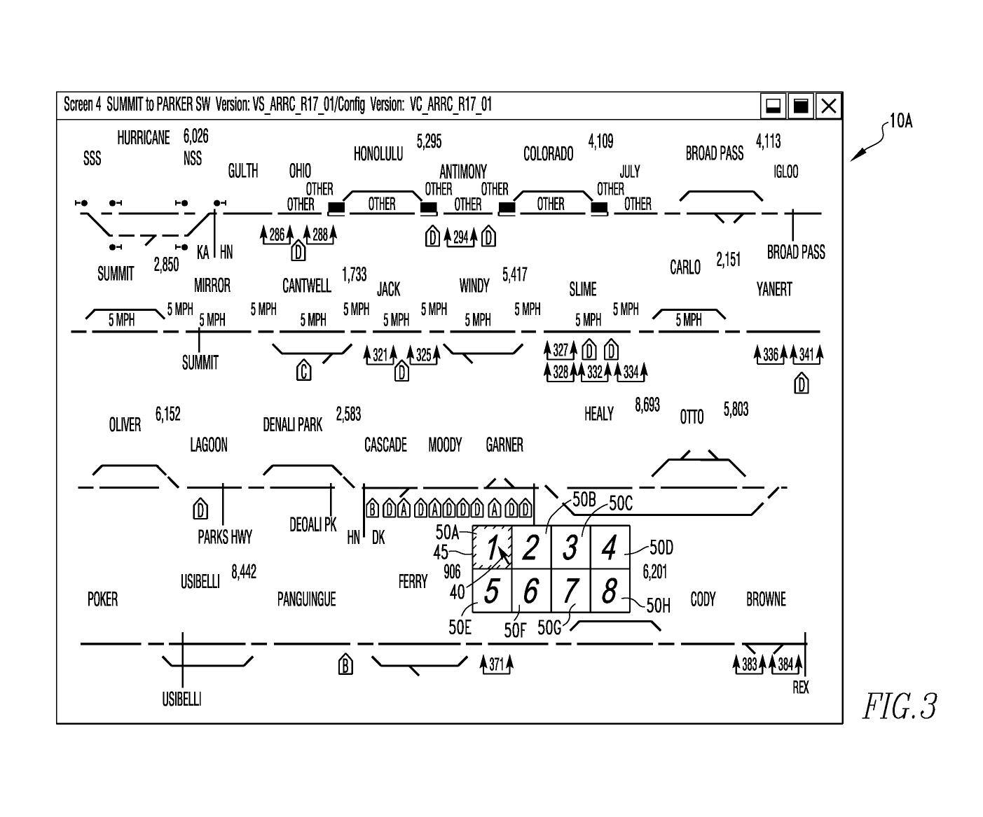

As shown in FIG. 3, in response to such input, a discrete navigation interface mechanism 45 is displayed on the currently active monitor, which in the example shown is monitor 10A. The discrete navigation interface mechanism 45 includes a number of monitor representations, preferably in the form of monitor cells 50A through 50H shown in FIG. 3. Each monitor cell 50A through 50H corresponds to the like positioned monitor 10A through 10H and is preferably a user selectable icon. In other words, the discrete navigation interface mechanism 45 preferably comprises a grid which represents the physical layout of the monitors 10A through 10H forming a part of the dispatcher's workstation 5. Preferably, an indication is provided to identify the currently active monitor, which in the example shown is monitor 10A. For example, as seen in FIG. 3, the cell 50A which corresponds to the currently active monitor 10A could be provided in a different color or with a different shading or outline in order to set it apart from the other cells 50B through 50H.

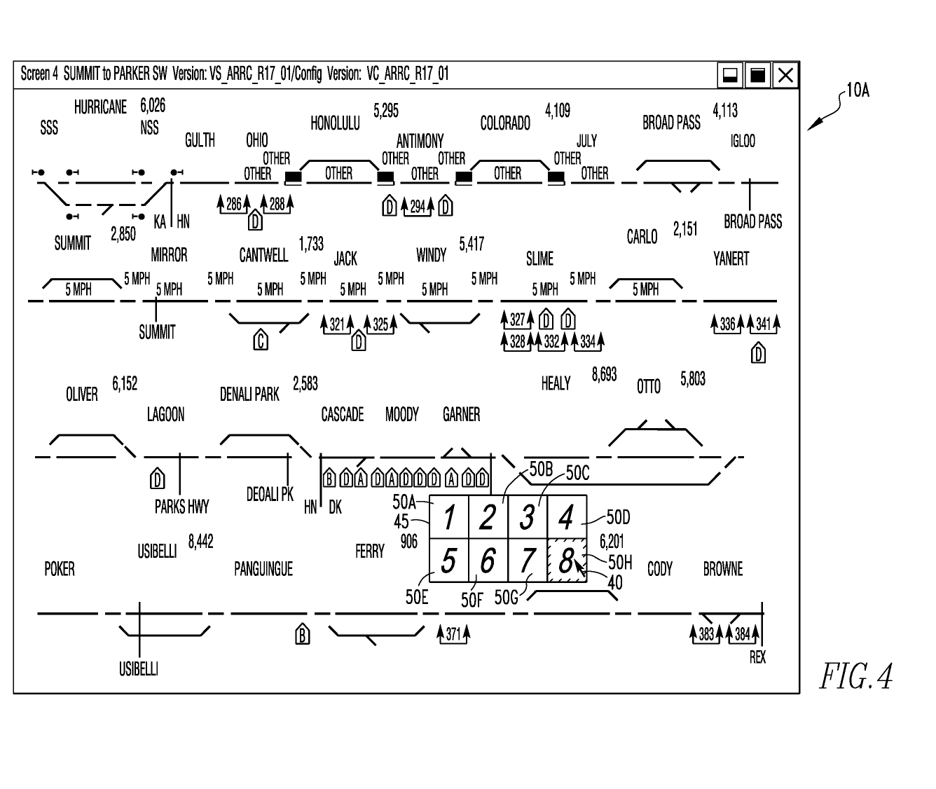

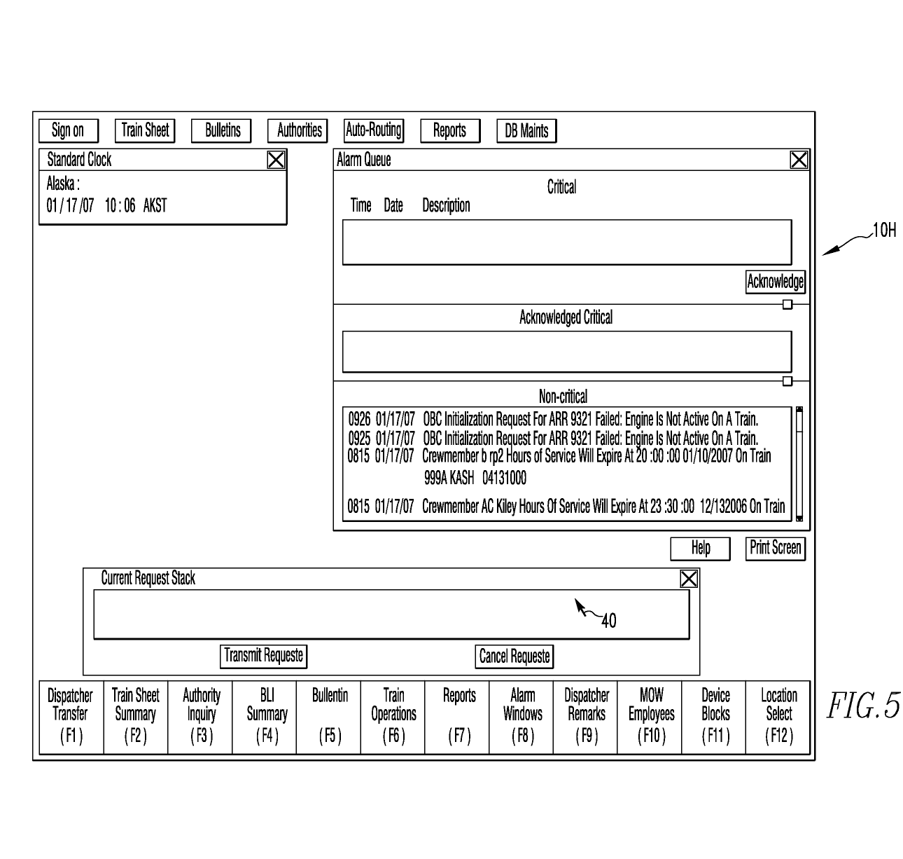

To discretely move the pointer 40 from the currently active monitor 10A to another one of the monitors 10B through 10H, the dispatcher moves the pointer 40 (using the mouse 20) to the cell 50B through 50H that corresponds to and represents the desired monitor 10B through 10H. Preferably, the different shading or highlighting or other indicator that was previously setting cell 50A apart from the other cells 50B through 50H would move with the pointer 40 to the cell 50B through 50H that the dispatcher wishes to select. For example, as seen in FIG. 4, if the dispatcher desires to activate the monitor 10H and move the pointer 40 to the monitor 10H, the dispatcher moves the pointer 40 from the cell 50A to the cell 50H, which would then be set apart from the others. Once the pointer 40 is within the desired cell 50H which represents the desired monitor 10H, the dispatcher would select that cell 50H by, for example, clicking a button provided as part of the mouse 20. In response to such a selection, the discrete navigation interface mechanism 45 would be dismissed, the monitor 10H would become active, and the pointer 40 would immediately jump to (i.e., be displayed on) the monitor 10H. This is shown in FIG. 5. Preferably, the pointer 40 would be displayed at a position on the monitor 10H having X,Y coordinates that are the same as the X,Y coordinates at which the pointer 40 was located when the discrete navigation function was activated. Alternatively, the pointer 40 could be displayed at a position on the monitor 10H having X,Y coordinates that are the same as the X,Y coordinates at which the pointer 40 was last displayed on monitor 10A.

If after activating the discrete navigation interface mechanism, the dispatcher decides he or she wants to dismiss the discrete navigation interface mechanism 45 without navigating to another monitor, the dispatcher could either move the pointer 40 outside of the grid which includes the cells 50A through 50H, which would automatically deactivate the function associated with the discrete navigation interface mechanism 45 and remove it from the current monitor, or the dispatcher could select the cell 50A through 50H which corresponds to the then current monitor 10A. Preferably, as described elsewhere herein, there is an indication on the then current monitor 10A, such as a heavier border around the cell 50A of a different shading for the cell 50A, which indicates that monitor 10A is current. Thus, there is no question on the part of the user regarding which is the current monitor.

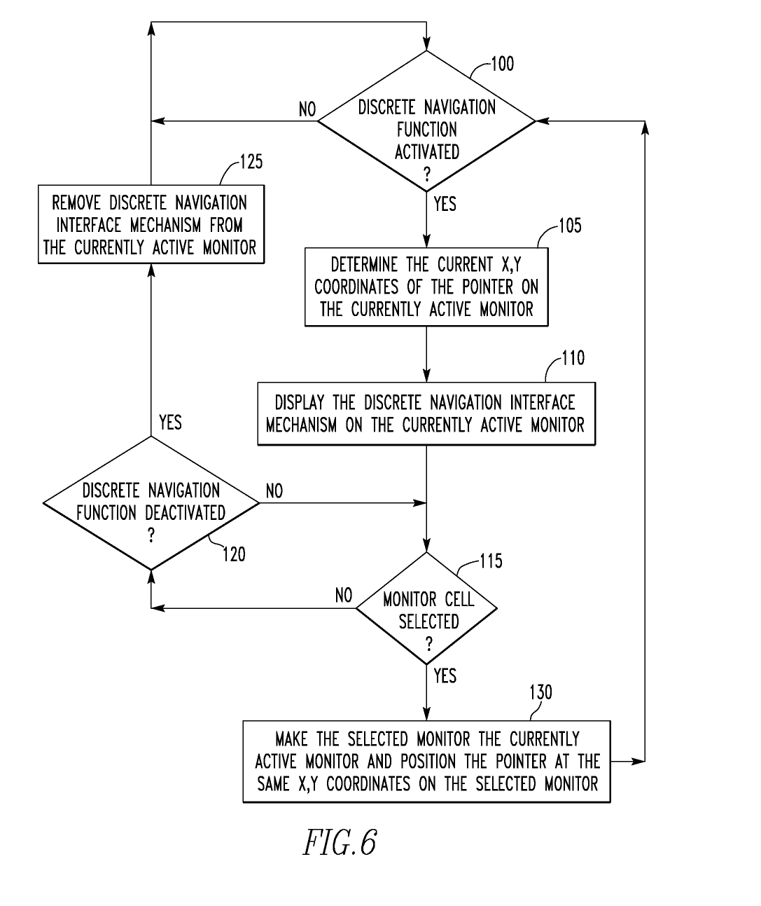

FIG. 6 is a flowchart which illustrates a method of facilitating navigation among multiple monitors in a multiple monitor workstation according to one embodiment of the invention. The method depicted in FIG. 6 may be implemented in software routines which are stored in the memory 35 and which are executable by the processing unit 30 of the dispatcher's workstation 5, and for illustrative purposes, the method will be described herein in connection with such an implementation.

Referring to FIG. 6, the method begins at step 100, wherein a determination is made as to whether the dispatcher has activated the discrete navigation function in, for example, a manner described elsewhere herein such as by clicking a particular button of the mouse 20. If the answer is no, then, as shown in FIG. 6, the method awaits such an activation. If, however, the answer at step 100 is yes, then, at step 105, the current X,Y coordinates of the pointer 40 on the currently active monitor 10A through 10H (10A will be used as an example for purposes of this discussion) are determined. Next, at step 110, the discrete navigation interface mechanism 45 is displayed on the currently active monitor 10A. Then, at step 115, a determination is made as to whether one of the cells 50B through 50H have been selected in a manner described elsewhere herein. If the answer at step 115 is no, then, at step 120, a determination is made as to whether the navigation function has been deactivated in, for example, a manner described elsewhere herein. If the answer at step 120 is yes, then the method returns to step 100 to await the reactivation of the discrete navigation function. If the answer at step 120 is no, then the method returns to step 115 to determine whether a cell 50B through 50H has been selected.

If, however, the answer at step 115 is yes, meaning that one of the cells 50B through 50H corresponding to one of the monitors 10B through 10H has been selected, the method proceeds to step 120. At step 120, the monitor 10B through 10H which corresponds to the particular cell 50B through 50H which was selected at step 115 is made the currently active monitor and the pointer 40 is positioned at X,Y coordinates on the selected monitor 10B through 10H which correspond to the X,Y coordinates determined in step 105. At step 130, since a new monitor 10B through 10H has been selected and made active, the discrete navigation interface mechanism 45 will not be displayed on the newly active monitor 10B through 10H and the discrete navigation function will no longer be active. Thus, following step 130, the method thus returns to step 100 to await reactivation of the discrete navigation function.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of navigating among a plurality of monitors of a multiple monitor workstation, comprising:
receiving a request to navigate among said monitors when a position indictor is displayed on a first one of said monitors, said first one of said monitors being active;
in response to said request, displaying a navigation interface mechanism on said first one of said monitors, said navigation interface mechanism including a plurality of monitor representations, each of said monitor representations corresponding to a respective one of said monitors;
receiving a selection of one of said monitor representations, said one of said monitor representations corresponding to a second one of said monitors; and
making said second one of said monitors active and displaying said position indicator on said second one of said monitors.

2. The method according to claim 1, further comprising deactivating said first one of said monitors and no longer displaying said position indicator on said first one of said monitors after the step of receiving a selection of one of said monitors.

3. The method according to claim 1, wherein said position indicator is a pointer.

4. The method according to claim 3, wherein said pointer is a mouse pointer.

5. The method according to claim 1, wherein each of said monitor representations is a cell displayed on said first one of said monitors.

6. The method according to claim 5, wherein each of the cells together form a grid.

7. The method according to claim 6, wherein said monitors are arranged in an arrangement, and wherein a position of each said cell in said grid corresponds to a position of the monitor to which the cell corresponds in said arrangement.

8. The method according to claim 5, wherein each said cell is a user selectable icon.

9. The method according to claim 1, further comprising distinguishing said one of said monitor representations from the other ones of said monitor representations when said first one of said monitors is active.

10. The method according to claim 1, further comprising determining a set of X,Y coordinates of said position indicator on said first one of said monitors and wherein said step of displaying said position indicator on said second one of said monitors comprises displaying said position indicator at a position on said second one of said monitors corresponding to said set of X,Y coordinates.

11. A computer readable medium having computer executable instructions for performing the method recited in claim 1.

12. A workstation comprising:
a plurality of monitors
a processing unit operatively coupled to each of said monitors; and
a memory operatively coupled to said processing unit having one or more routines executable by said processing unit, said one or more routines being adapted to:
receive a request to navigate among said monitors when a position indictor is displayed on a first one of said monitors, said first one of said monitors being active;
in response to said request, display a navigation interface mechanism on said first one of said monitors, said navigation interface mechanism including a plurality of monitor representations, each of said monitor representations corresponding to a respective one of said monitors;
receive a selection of one of said monitor representations, said one of said monitor representations corresponding to a second one of said monitors; and
make said second one of said monitors active and display said position indicator on said second one of said monitors.

13. The workstation according to claim 12, said one or more routines being further adapted to deactivate said first one of said monitors and no longer display said position indicator on said first one of said monitors after the receipt of a selection of one of said monitors.

14. The workstation according to claim 12, wherein each of said monitor representations is a cell displayed on said first one of said monitors.

15. The workstation according to claim 14, wherein each of the cells together form a grid.

16. The workstation according to claim 15, wherein said monitors are arranged in an arrangement, and wherein a position of each said cell in said grid corresponds to a position of the monitor to which the cell corresponds in said arrangement.

17. The workstation according to claim 14, wherein each said cell is a user selectable icon.

18. The workstation according to claim 12, said one or more routines being further adapted to distinguish said one of said monitor representations from the other ones of said monitor representations when said first one of said monitors is active.

19. The workstation according to claim 12, said one or more routines being further adapted to determine a set of X,Y coordinates of said position indicator on said first one of said monitors and display said position indicator at a position on said second one of said monitors corresponding to said set of X,Y coordinates.
